(19) United States
(12) Patent Application Publication
(10) Pub. No.: US 2011/0106819 A1
(43) Pub. Date: May 5, 2011

(54) IDENTIFYING A GROUP OF RELATED INSTANCES

(75) Inventors: Randolph G. Brown, Sunnyside, NY (US); Daniel N. Quine, London (GB); Yohann R. Coppel, Mountain View, CA (US); Daniel Loreto, New Rochelle, NY (US); John Alexander Komoroske, New York, NY (US); Andrew William Hogue, Ho-Ho-Kus, NJ (US); Craig Nevill-Manning, New York, NY (US)

(73) Assignee: GOOGLE INC., Mountain View, CA (US)

(21) Appl. No.: 12/608,395

(22) Filed: Oct. 29, 2009

(51) Int. Cl. G06F 17/30

(52) U.S. Cl. 707/749; 707/E17.017

(57) ABSTRACT

Methods, systems, and apparatus, including computer programs encoded on a computer storage medium, for identifying a group of related instance identifiers. In one aspect, a computer storage medium is encoded with a computer program. The program comprises instructions that when executed by data processing apparatus cause the data processing apparatus to perform operations. The operations include receiving a search query at a data processing apparatus, the search query specifying attributes shared by a group of related instances, searching an electronic document collection to identify instance identifiers that are responsive to the search query, representing features of the instance identifiers in a vertex-edge graph, and scoring relevance of the instance identifiers to the search query according to the features represented in the vertex-edge graph.

### BACKGROUND

This specification relates to the identification of a group of related instances, e.g., by searching a unstructured collection of electronic documents.

Instances are individually identifiable entities. Instances can be grouped according to their attributes. An attribute is a property, feature, or characteristic of an instance. A group of instances can be defined by one or more attributes. The instances that belong to a group are determined by the attributes that define the group. For example, the instances New York, Chicago, and Tokyo can be grouped together as cities, whereas Tokyo is excluded from a group of North American cities.

Search is an automated process in which a user enters a search query and receives responsive results in a result set. The result set can include content that is responsive to the search query and drawn from a collection of electronic documents. An electronic document is a collection of machine-readable digital data. Electronic documents are generally individual files and formatted in accordance with a defined format (e.g., PDF, TIFF, HTML, XML, MS Word, PCL, PostScript, or the like). An electronic document collection can be stored as digital data on one or more data storage devices.

Electronic document collections can either be unstructured or structured. The formatting of the documents in an unstructured electronic document collection is not constrained to conform with a predetermined structure and can evolve in often unforeseen ways. In other words, the formatting of individual documents in an unstructured electronic document collection is neither restrictive nor permanent across the document collection. Further, in an unstructured electronic document collection, there are no mechanisms for ensuring that new documents adhere to a format or that changes to a format are applied to previously existing documents. Thus, the documents in an unstructured electronic document collection cannot be expected to share a common structure that can be exploited in the extraction of information. Examples of unstructured electronic document collections include the documents available on the Internet, collections of resumes, collections of journal articles, and collections of news articles. Documents in some unstructured electronic document collections are not prohibited from including links to other documents inside and outside of the collection.

In contrast, the documents in structured electronic document collections generally conform with formats that can be both restrictive and permanent. The formats imposed on documents in structured electronic document collections can be restrictive in that common formats are applied to all of the documents in the collections, even when the applied formats are not completely appropriate. The formats can be permanent in that an upfront commitment to a particular format by the party who assembles the structured electronic document collection is generally required. Further, users of the collections—in particular, computer programs that use the documents in the collection—rely on the documents' having the expected format. As a result, format changes can be difficult to implement. Structured electronic document collections are best suited to applications where the information content lends itself to simple and stable categorizations. Thus, the documents in a structured electronic document collection generally share a common structure that can be exploited in the extraction of information. Examples of structured electronic document collections include databases that are organized and viewed through a database management system (DBMS) in accordance with hierarchical and relational data models, as well as a collections of electronic documents that are created by a single entity for presenting information consistently. For example, a collection of web pages that are provided by an online bookseller to present information about individual books can form a structured electronic document collection. As another example, a collection of web pages that is created by server-side scripts and viewed through an application server can form a structured electronic document collection. Thus, one or more structured electronic document collections can each be a subset of an unstructured electronic document collection.

### SUMMARY

This specification describes technologies relating to the identification of one or more groups of related instances. In some implementations, the groups of related instance identifiers are identified by searching an unstructured collection of electronic documents, for example, the electronic documents available on the Internet.

In general, one innovative aspect of the subject matter described in this specification can be embodied in methods performed by one or more data processing apparatus that include the actions of the data processing apparatus receiving a search query at a data processing apparatus, the data processing apparatus identifying groups of instance identifiers in an unstructured collection of electronic documents with the data processing apparatus, the data processing apparatus determining relevance of the groups of instance identifiers to the search query with the data processing apparatus, and the data processing apparatus scoring at least some of the instance identifiers in the groups of instance identifiers individually with the data processing apparatus; and the data processing apparatus ranking the at least some instance identifiers according to the scores with the data processing apparatus. The search query specifies attributes shared by a group of related instances.

Other embodiments of this aspect include corresponding systems, apparatus, and computer programs, configured to perform the actions of the methods, encoded on computer storage devices.

These and other embodiments can each optionally include one or more of the following features. Determining the relevance of the groups of instance identifiers to the search query can include computing relevance of the groups of instance identifiers to source documents that include the groups of instance identifiers, computing likelihoods that the identified groups of instance identifiers are indeed groups of instance identifiers, and computing relevance of source documents which include the groups of instance identifiers to the search query. Identifying the groups of instance identifiers can include forming a first new query biased to identify groups, forming a second new query constrained to search compendia sources, and searching the unstructured collection of electronic documents with the received query, the first new query, and the second new query.

The method can also include the data processing apparatus rescoring the at least some instance identifiers before ranking Scoring at least some of the instance identifiers in the groups of instance identifiers can include representing features of the instance identifiers in a vertex-edge graph and scoring the instance identifiers according to the features represented in the vertex-edge graph. The vertices in the vertex-edge graph can represent groups of instance identifiers. Respective edges in the vertex-edge graph can be weighted according to overlap between the vertices connected by the edge. Vertices in the vertex-edge graph can represent individual instance identifiers. Respective edges in the vertex-edge graph represent features shared by the instance identifiers. A first edge in the vertex-edge graph can represent an extractor that identified a pair of vertices joined by the first edge. A first edge in the vertex-edge graph can represent other instance identifiers in potential groups where vertices joined by the first edge are found. A first edge in the vertex-edge graph can represent a class of the query that identified source document where vertices joined by the first edge are found. Scoring the instance identifiers can include identifying cliques in the vertex-edge graph. Scoring the instances identifiers can include scoring the instance identifiers using a predictive analytic tree-building algorithm. Scoring the instance identifiers using the predictive analytic tree-building algorithm can include training the predictive analytic tree-building algorithm using a group of instance identifiers of confirmed accuracy that are relevant to a search query, a set of potential groups of instance identifiers that have been identified from an unstructured collection of electronic documents, and features of the instance identifiers in the potential groups and generating a classification and regression tree.

Another innovative aspect of the subject matter described in this specification can be embodied in computer storage media encoded with a computer program. The programs can include instructions that when executed by data processing apparatus cause a data processing apparatus to perform operations. The operations can include receiving a search query at a data processing apparatus, the search query specifying attributes shared by a group of related instances, searching an electronic document collection to identify identifiers of instance that are responsive to the search query, representing features of the instance identifiers in a vertex-edge graph, and scoring relevance of the instance identifiers to the search query according to the features represented in the vertex-edge graph.

Other embodiments of this aspect include corresponding systems, apparatus, and methods, configured to perform the actions of the operations.

These and other embodiments can each optionally include one or more of the following features. The operations can also include identifying groups of instance identifiers in the electronic documents of the collection and determining relevance of the groups of instance identifiers to the search query. A first feature represented in the vertex-edge graph can include the relevance of the groups that include respective instance identifiers to the search query. The operations can also include identifying electronic documents available on the Internet that are relevant to the search query and extracting groups of instance identifiers from the electronic documents that are relevant to the search query. The operations can also include computing relevance of the electronic documents from which the groups of instance identifiers are extracted to the search query, computing relevance of the groups of instance identifiers to the electronic documents from which the groups of instance identifiers are extracted, and computing likelihoods that the groups of instance identifiers are groups of instance identifiers.

Identifying the groups of instance identifiers can include forming a new query biased to identify groups and searching the electronic document collection with the new query. A first edge in the vertex-edge graph can represent a class of the query that identified a pair of vertices joined by the first edge. A first edge in the vertex-edge graph can represent other instance identifiers in potential groups where vertices joined by the first edge are found. Scoring relevance of the instance identifiers to the search query can include identifying cliques in the vertex-edge graph.

Another innovative aspect of the subject matter described in this specification can be embodied in systems that include a client device and one or more computers programmed to interact with the client device and the data storage device. The computers are programmed to perform operations comprising receiving a search query from the client device, the search query explicitly or implicitly specifying attributes of instances, searching an electronic document collection to identify identifiers of instances that may have the attributes specified by the search query, representing features of the search of the electronic document collection in a vertex-edge graph, scoring the instance identifiers that may have the attributes specified by the search query according to the features represented in the vertex-edge graph, and outputting, the client device, instructions for visually presenting at least some of the instance identifiers.

Other embodiments of this aspect include corresponding methods and computer programs encoded on computer storage devices configured to perform the operations of the computers.

These and other embodiments can each optionally include one or more of the following features. Outputting the instructions can include outputting instructions for visually presenting a structured presentation at the client device and the client device is configured to receive the instructions and cause the structured presentation to be visually presented. The system can include a data storage device storing a data describing multiple groups of instances. The system can include a data storage device storing machine-readable instructions tailored to identify and extract groups of instance identifiers from electronic documents in an unstructured collection. Representing features can include representing the relevance of the groups in which the instance identifiers appear in the vertex-edge graph. Scoring the instance identifiers can include scoring the instance identifiers individually according to the relevance of the groups in which the instance identifiers appear to the search query. Scoring the instance identifiers can include identifying cliques in the vertex-edge graph. Scoring the instance identifiers can include scoring the instance identifiers according to an extractor represented in the vertex-edge graph. Scoring the instance identifiers can include scoring the instance identifiers according to a class of a query represented in the vertex-edge graph.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic representation of a system in which a group of related instances is identified.

FIG. 2 is a flow chart of a process for identifying a group of related instances.

FIG. 3 is a schematic representation of a process for identifying a group of related instances.

FIG. 4 is a flow chart of a process for identifying electronic documents relevant to a query.

FIG. 5 is a schematic representation of a process for identifying electronic documents relevant to a query.

FIG. 6 is a flow chart of a process for determining the relevance of groups of instances to a search query.

FIG. 7 is a flow chart of a process for scoring instances according to relevance of groups in which instances appear.

FIG. 8 is a flow chart of a process for scoring instances according to the relevance of groups in which instances appear.

FIG. 9 is a schematic representation of a vertex-edge graph that represents features of the instances in the potential groups.

FIG. 10 is a schematic representation of another vertex-edge graph that represents features of the instances in the potential groups.

FIG. 11 is a flow chart of a process for rescoring instances.

FIGS. 12-14 are examples of structured presentations that present a group of related instances to user.

Like reference numbers and designations in the various drawings indicate like elements.

### DETAILED DESCRIPTION

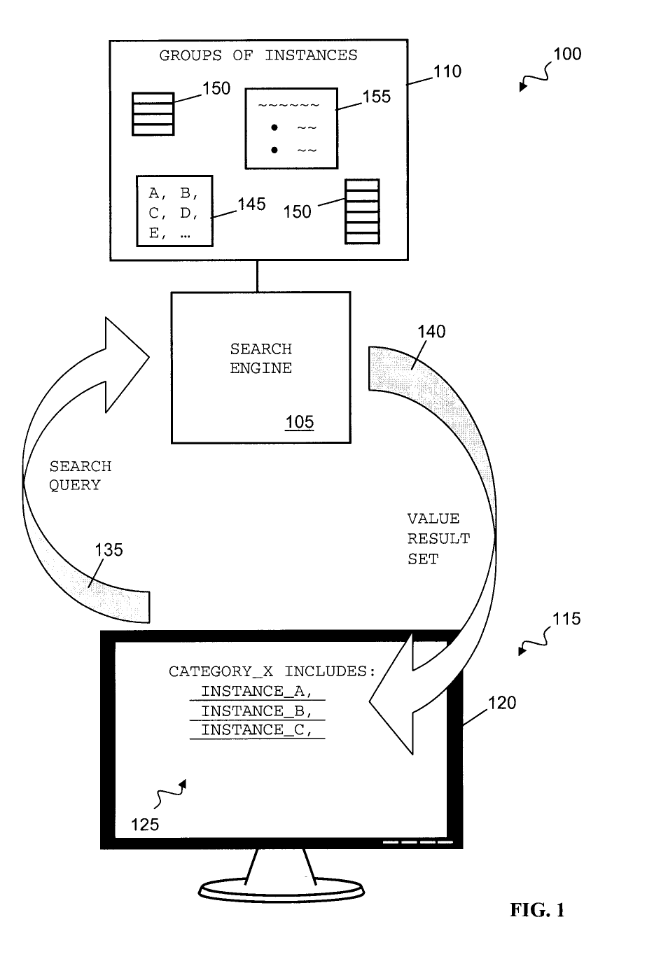

FIG. 1 is a schematic representation of a system 100 in which a group of related instances is identified. Related instances are instances that share one or more common attributes. In system 100, a group of related instances is identified in response to a search query. The search query specifies the attributes that are shared by the related instances. The attributes that are shared by a group of related instances can be specified by the search query explicitly, implicitly, or both explicitly and implicitly. For example, a search query “cities” implicitly specifies instances of discrete densely populated urban areas. As another example, a search query “cities located in North America” explicitly identifies that such urban areas are to be located in North America.

System 100 includes a search engine 105, a collection 110 of groups of identifiers of instances, and a client 115. Client 115 is a device for interacting with a user and can be implemented as a computer programmed with machine-readable instructions. Client 115 can include one or more input/output devices and can receive, from a user, a search query that specifies the attributes that are shared by a group of related instances. For example, a user who is currently interacting with client 115 can enter a search query using an input device such as a mouse or a keyboard. The search query can include text. Examples of textual search queries include “US presidents” and “North American cities.” As another example, a user can enter a search query by interacting with or referring to a graphical elements displayed on display screen 120. For example, a user can click on a cell in a structured presentation or formulate a search query that refers to a feature that appears in a structured presentation (e.g., “ROW_{—}1”). Structured presentations are described in more detail below.

Client 115 can also present a group of identifiers of related instances that shares the attributes specified by the search query. In the illustrated example, client 115 includes a display screen 120 that displays a presentation 125. Presentation 125 indicates that a group (i.e., “CATEGORY_X”) includes a collection of related instances (i.e., identified by identifiers “INSTANCE_A,” “INSTANCE_B,” and “INSTANCE_C”). In the illustrated implementation, presentation 125 is text. Other presentations can indicate that a group includes a collection of related instances. For example, structured presentations can identify a group in a column header and a collection of related instances in the cells in the column under that header.

In response to receipt of the search query, client 115 transmits a representation of the search query, or the search query itself, to search engine 105 in a message 135. Message 135 can be transmitted over a data communications network. Search engine 105 can receive message 135 and use the content of message 135 to define parameters for searching.

Search engine 105 can be implemented on one or more computers deployed at one or more geographical locations that are programmed with one or more sets of machine-readable instructions for identifying a relevant group of related instances from the groups of instances in collection 110. In some implementations, other functionality—i.e., functionality in addition to the functionality of search engine 105—can be implemented on the one or more computers. Search engine 105 identifies a relevant group of related instances according to the parameters for searching defined by the content of message 135. The search can yield a result set of relevant instances responsive to the search query described in message 135. The content of the result set, the arrangement of instances in the result set, or both can reflect the likelihood that the constituent instances are relevant to the search query. In some implementations, the content or arrangement of instances in the result set can also reflect other factors, such as the relative importance of the instances or a confidence that the instances are indeed responsive to the search query.

The groups of identifiers of instances in collection 110 can be found in or drawn from electronic documents of an unstructured electronic documents collection. For example, collection 110 can be groups of identifiers of instances that are found in electronic documents available on the Internet. The source documents of the groups of identifiers of instances are thus not necessarily constrained to conform with a predetermined structure that can be exploited for the extraction of information. For this reason, one or more computers can execute one or more sets of machine-readable instructions that are tailored to identify and extract groups of identifiers of instances from an unstructured electronic documents collection. Machine-readable instructions that are tailored in this way can be referred to as “extractors.”

Collection 110 can include, e.g., lists of instance identifiers 145, tables of instance identifiers 150, and structured text 155 that includes instance identifiers. A list of instance identifiers 145 is an ordered series of words or numerals. A list of instance identifiers can be found in text and identifiable, e.g., by grammatical conventions or mark-up tags. For example, the instance identifiers in a list can be delineated by commas or semicolons in text. A table of instance identifiers 150 is a systematic arrangement of instance identifiers. For example, instance identifiers can be arranged in rows or columns. In electronic documents, tables can be identified, e.g., by lines or spaces that delineate rows and columns or by mark-up tags. Structured text 155 includes other structured arrangements of instance identifiers, such as instance identifiers ordered by bullet points or instances in a series of paragraph headings. In electronic documents, structured text 155 can be identified, e.g., by the structural features of the arrangement of instances or by mark-up tags.

In some implementations, collection 110 can also include groups of one or more instance identifiers that are formed using text extraction techniques. In particular, textual patterns that explicitly or implicitly indicate that an identified instance has certain attributes can be used to form groups of one or more instance identifiers. For example, text such as “New York, the largest city in North America, . . . ” and “Quebec was the first North American city to be designated a UNESCO World Heritage Site . . . ” can be identified using pattern identification techniques. For example, text extraction techniques using Hearst patterns or the approaches described in, e.g., “The Role of Documents vs. Queries in Extracting Class Attributes from Text,” by M. Pasca, B. Van Durme, and N. Garera (CIKM'07, Nov. 6-8, 2007, Lisboa, Portugal) and “Weakly-Supervised Acquisition of Open-Domain Classes and Class Attributes fromWeb Documents and Query Logs” by M. Pasca, B. Van Durme (Proceedings of ACL-08: HLT, pages 19-27, Columbus, Ohio, USA, June 2008) can be used. Instance identifiers can be extracted from text and combined to form a group of instance identifiers having the attributes explicitly and implicitly associated with, e.g., North American cities. Extractors can use such characteristics to identify and extract groups of instances from an unstructured electronic documents collection.

Search engine 105 can transmit a representation of the result set to client 115 in a message 140. Message 140 can be transmitted, e.g., over the same data communications network that transmitted message 135. Client 115 can receive message 140 and use the content of message 140 to display a presentation 125 on display screen 120. Presentation 125 indicates that one or more common attributes are shared by a group of instances, namely, at least some the instances in the result set described in message 135. In some implementations, presentation 125 can use text to identify the shared attributes and instance identifiers. For example, in the illustrated implementation presentation 125 describes that instance identified as “INSTANCE_A,” “INSTANCE_B,” and “INSTANCE_C” share the attribute of belonging to a category “CATEGORY_X.” Category “CATEGORY_X” can explicitly or implicitly specify the attributes shared by instance identified as “INSTANCE_A,” “INSTANCE_B,” and “INSTANCE_C.”

In some implementations, presentation 125 can use the spatial arrangement and positioning of information to identify that a group of instance shares one or more common attributes. For example, presentation 125 can be a structured presentation, as described further below.

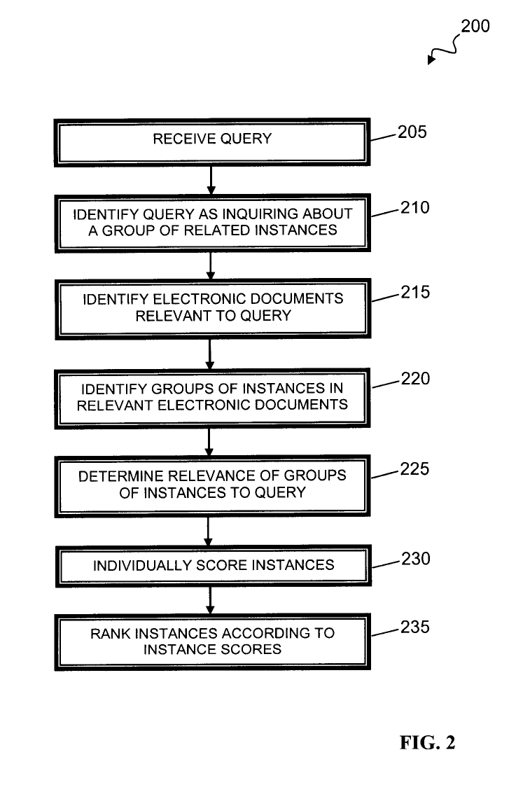

FIG. 2 is a flow chart of a process 200 for identifying a group of related instance identifiers. Process 200 can be performed by one or more computers that perform operations by executing one or more sets of machine-readable instructions. For example, process 200 can be performed by the search engine 105 in system 100.

The system performing process 200 receives a query (step 205). For example, in the context of system 100 (FIG. 1), the system can receive a representation of the search query or the search query itself in message 135 over a data communications network.

The system performing process 200 identifies that the query inquires about a group of related instances (step 210). The query can be identified as inquiring about a group of related instances from the content of the query, the context of the query, or both. For example, the terms in a text search query “cities in California” can be identified as inquiring about a group of related instances such as “San Diego,” “Los Angeles,” and “Bakersfield” due to the plural term “cities” being characterized by a common attribute of those instances, namely, being “in California.” As another example, the terms in a search query “Ivy League schools” can be identified as inquiring about a group of related instances (such as “Cornell,” “Columbia,” and “Brown”) due to the plural term “schools” being characterized by a common attribute “Ivy League.” The context of the receipt of the search query can also be used to identify that a query inquires about a group of related instances. For example, an express indication by a user or the history of previous queries can be used to identify that a search query inquires about a group of related instances.

The system performing process 200 identifies electronic documents that are relevant to the search query (step 215). The electronic documents can be identified by matching text, concepts, or both to entries in an indexed database of electronic documents. The match between the text or concepts in the electronic documents can be used to determine a page rank that embodies the relevance of the electronic documents to the search query, as well as other factors. Examples of these other factors include, e.g., the age of the electronic document, the number of links from other electronic documents to the electronic document, the likelihood that the electronic document is a “spam document,” and the like.

The system performing process 200 identifies groups of instance identifiers in the relevant electronic documents (step 220). For example, groups of instance identifiers can be identified by delineations, mark-up tags, or other characteristics of the arrangement of instance identifiers in the relevant electronic documents. In some implementations, the groups of instance identifiers can be extracted from their respective source electronic documents and assembled into a collection, e.g., collection 110 in system 100 (FIG. 1).

The system performing process 200 determines the relevance of each group of instance identifiers to the search query (step 225). In general, the relevance of a group of instance identifiers to a search query will differ from the relevance or page rank of its source electronic document to that same query. For example, at least some of the text and concepts that appear in a source electronic document will generally be omitted from a group of instance identifiers in that document. In some implementations, the relevance of a group of instance identifiers can be determined according to the relevance or page rank of its source electronic document and other factors, as described further below.

The system performing process 200 scores the relevance of the instances that appear in the groups individually (step 230). The scores of the individual instance identifiers can embody the likelihood that each individual instance is relevant to the search query. In some implementations, individual instance identifiers are scored according to the relevance of the groups in which the instance identifiers appear, the overlap between the instance identifiers that appear in different groups, other features of the search that identified the groups in which the instance identifiers appeared, or combinations of these and other factors. A single group of instance identifiers from a single source electronic document can thus include a collection of instance identifiers that are scored differently. Examples of different approaches to scoring the relevance of groups are described further below.

The system performing process 200 ranks the individual instance identifiers according to their scores (step 235). The ranking can characterize the likelihood that individual instances are relevant to the search query. For example, an instance with a high ranking is one that is likely to be an entity that has the attributes explicitly or implicitly identified in the search query. On the other hand, an instance with a low ranking is one that is unlikely to be an entity that has the attributes explicitly or implicitly identified in the search query. The ranked instance identifiers can be output in a result set provided to a user, e.g., in a message transmitted over a data transmission network, e.g., message 140 (FIG. 1).

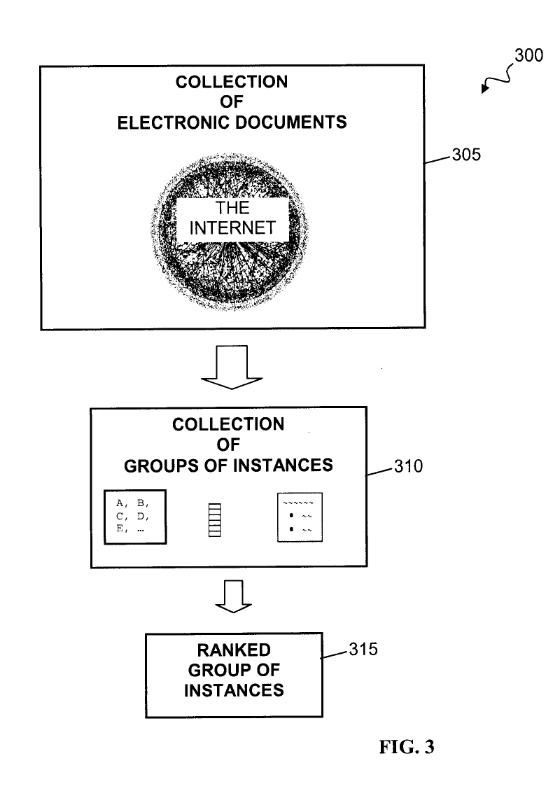

FIG. 3 is a schematic representation 300 of a process for identifying a group of related instance identifiers. The process can be performed by one or more computers that perform operations by executing one or more sets of machine-readable instructions. For example, representation 300 can represent the identification of related instance identifiers using process such as process 200 (FIG. 2) in a system such as system 100 (FIG. 1).

A collection of electronic documents 305 can be searched to yield a collection 310 of groups of instance identifiers. Collection 305 can be an unstructured collection of electronic documents 305. The search can be performed in response to a search query that is used to define parameters for searching. The search can identify relevant documents that include groups of instance identifiers. These groups of instance identifiers can be extracted from their respective source documents to yield collection 310.

The individual instance identifiers within the groups of instances in collection 310 can then be ranked according to relevance to the search query. The instances can thus be entities that share one or more attributes implicitly or explicitly identified in the search query. The ranked instance identifiers can be output in a result set provided to a user. In some implementations, the top-ranked instance identifiers can be found in different groups of instance identifiers in collection 310. For example, the highest-ranked instance identifier may be found in a first group of instance identifiers, whereas the second highest-ranked instance identifier may be absent from that first group of instance identifiers.

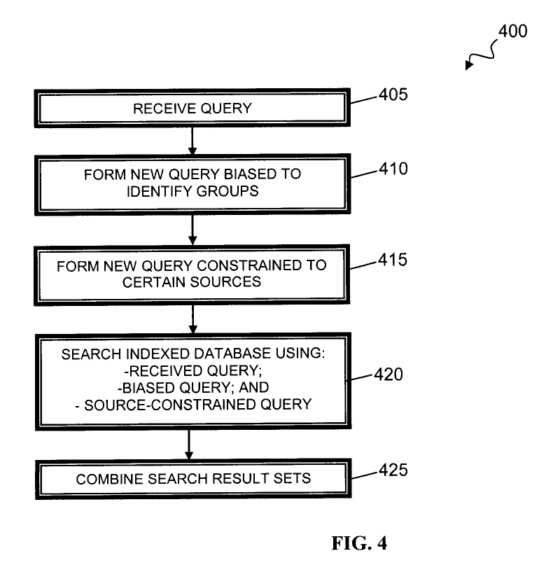

FIG. 4 is a flow chart of a process 400 for identifying electronic documents relevant to a query. Process 400 can be performed by one or more computers that perform digital data processing operations by executing one or more sets of machine-readable instructions. For example, process 400 can be performed by the search engine 105 in system 100 (FIG. 1). Process 400 can be performed in isolation or in conjunction with other digital data processing operations. For example, process 400 can be performed in conjunction with the activities of process 200, e.g., at step 215 (FIG. 2).

The system performing process 400 receives a search query (step 405). For example, in the context of system 100 (FIG. 1), the system can receive a representation of the search query or the search query itself in message 135 over a data communications network.

The system performing process 400 forms one or more new search queries that are biased to identify groups of instance identifiers (step 410). Such a biased query can be formed by combining text or concepts represented in the received search query with text or concepts that are biased toward the identification of groups of instance identifiers. For example, text drawn from the received search query (e.g., “rollercoasters” or “hybrid vehicles”) can be combined with text biased toward the identification of groups (e.g., “list of [query text],” “this year's [query text],” “my favorite [query text],” “group of [query text],” “the best [query text],” “[query text] such as,” “[query text] including,” and the like).

In some implementations, a biased query can include text or concepts that are intended to prevent certain groups of instance identifiers from being identified by the biased query. For example, in some implementations, a collection of biased queries can be formed, with each including text that specifies a subcategory of a broader category specified by the query text. Examples of such biased queries include “[subcategory_{—}1] [query text] such as,” “[subcategory_{—}2] [query text] such as,” and “[subcategory_{—}3] [query text] such as.”

By way of example, suppose the search query “restaurants” is received. As discussed above, a query that is biased to identify groups of instance identifiers such as “[restaurants] including” can be formed. However, in addition to identifying individual restaurants (e.g., the instance identifiers “Bodo's Bagels,” “Point Loma Seafood,” and “Pat's Pizza”), this biased query could also identify identifiers of instances of culinary sub-categories of restaurants (e.g., “French restaurants,” “Italian restaurants,” “Thai restaurants,” and “fast food restaurants”). In such instances, text that specifies such sub-categories of the broader category can be included in a collection of biased queries. For example, biased queries such as “[French] [restaurants] including,” “[Italian] [restaurants] including,” and “[Thai] [restaurants] including,” “[fast food] [restaurants] including”) can be formed.

The system performing process 400 also forms one or more new search queries that are constrained to search certain sources (step 415). In some implementations, searches can be constrained to one or more compendia, such as encyclopedia (e.g., www.wikipedia.org) or dictionaries. In some implementations, the searched sources are constrained according to the subject mater of the query. For example, a search for “hybrid vehicles” may be constrained to searching news media and consumer agencies that deal with motor vehicles.

The system performing process 400 conducts a search using the received search query, the search queries that are biased to identify groups of instance identifiers, and the search queries that are constrained to search certain sources (step 420). The searches can be run in series or in parallel. The searches using the received search query and the biased search queries can be conducted on the same unstructured collection of electronic documents (e.g., the electronic documents available on the Internet). Each of the searches can yield a separate search result set that identifies electronic documents relevant to the respective search query. The individual documents in each search result set can be scored and ranked, e.g., according to the relevance to the respective search query and other factors.

The system performing process 400 combines the search result sets yielded by the different searches into a combined search result set (step 425). The electronic documents identified in the combined search result set can be ranked, e.g., according to the relevancy score or page rank determined in the individual searches. In some implementations, the relevancy scores or page ranks determined in the individual searches are normalized to a standard, e.g., so that the highest ranked electronic documents in each search result set are the three highest ranked electronic documents in the combined search result set. In other implementations, the relevancy scores or page ranks are weighted to prefer electronic documents found in multiple search result sets or electronic documents found in search result sets yielded by a certain one of the searches. For example, the relevancy scores or page ranks of electronic documents in search result sets yielded by queries that are constrained to search certain sources can be preferentially weighted to appear higher in the rankings of the combined search result set.

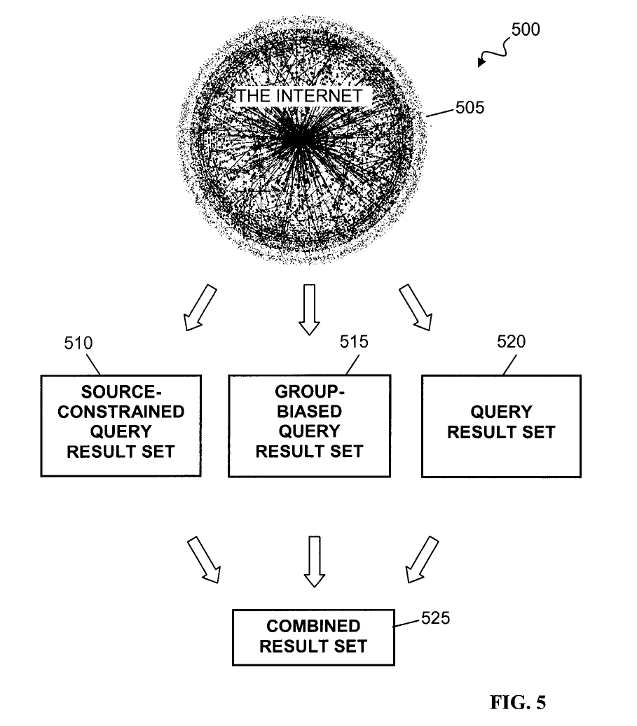

FIG. 5 is a schematic representation 500 of a process for identifying electronic documents relevant to a query. The process can be performed by one or more computers that perform operations by executing one or more sets of machine-readable instructions. For example, representation 500 can represent the identification of electronic documents using a process such as process 400 (FIG. 4) in a system such as system 100 (FIG. 1).

An unstructured collection 505 of electronic documents (e.g., the documents available on the Internet) can be searched multiple times to yield a source-constrained query result set 510, a result set 515 yielded by a query that is biased to identify groups, and a query result set 520. Result sets 510, 515, 520 can identify the same or different electronic documents in collection 505. Result sets 510, 515, 520 can be combined together to form a combined result set 525. Combined result set 525 identifies electronic documents which appear in unstructured collection 505.

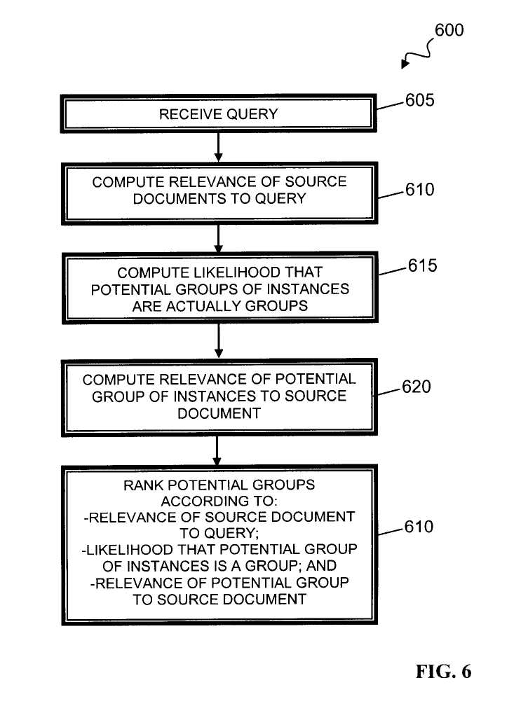

FIG. 6 is a flow chart of a process 600 for determining the relevance of groups of instance identifiers to a search query. Process 600 can be performed by one or more computers that perform digital data processing operations by executing one or more sets of machine-readable instructions. For example, process 600 can be performed by the search engine 105 in system 100 (FIG. 1). Process 600 can be performed in isolation or in conjunction with other digital data processing operations. For example, process 600 can be performed in conjunction with the activities of process 200, e.g., at step 225 (FIG. 2).

The system performing process 600 receives a search query (step 605). For example, in the context of system 100 (FIG. 1), the system can receive a representation of the search query or the search query itself in message 135 over a data communications network.

The system performing process 600 computes the relevance of each of a collection of source documents to the query (step 610). The relevance can be computed, e.g., by matching a query to text, concepts, or both in an electronic document. The match between the text or concepts in the electronic documents can be used to determine a page rank that embodies the relevance of the electronic documents to the search query and potentially other factors.

The system performing process 600 computes the likelihood that potential groups of instance identifiers in the source documents are actually groups of instance identifiers (step 615). As described above, delineations, mark-up tags, or other characteristics of the arrangement of instance identifiers in the relevant electronic documents can be used to identify potential groups of instance identifiers. In some circumstances, it is not completely certain that a group of instance identifiers has in fact been identified. For example, although commas are generally used to delineate members of a list in text, commas may sometimes be omitted from a list inadvertently or otherwise. In such cases, the certainty that a series of instance identifiers is in fact a list is decreased. As another example, different textual patterns can be more or less likely to exclusively identify instance identifiers that have certain attributes. The likelihood that a potential group of instance identifiers assembled using such textual patterns actually includes correct instance identifiers can be computed according to the accuracy of the textual patterns used.

As another example, mark-up HTML tags such as <b>, <li>, <td>, <a>, and the like can be used to identify potential groups of instance identifiers. However, such HTML tags do not always delineate lists of items. Instead, HTML authors can use them for other purposes. For example, the HTML tag <li>—which is designed to define list items—can also be used for other formatting purposes or to contain ancillary text that does not identify a group of instance identifiers. Thus, it is not completely certain that even mark-up tags designed to define a group of instance identifiers can actually be used to identify a group of instance identifiers.

The likelihood that a group of instance identifiers has been identified can be computed and expressed as a normalized value between absolute certainty that a group of instance identifiers has been identified (e.g., a “1”) and absolute certainty that a group of instance identifiers has not been identified (e.g., a “0”).

The system performing process 600 computes the relevance of each potential group of instance identifiers to the source document that includes the potential group (step 620). In some circumstances, a group of instance identifiers is unrelated to other content of the electronic document that includes the group of instance identifiers. For example, the cover page of a company newsletter may include a table setting forth the addresses where the company has offices. Although the table is a group of instance identifiers, the content of this table (e.g., office addresses) may be unrelated to other content of the newsletter. The system can compute the relevance of each potential group of instance identifiers to the source document that includes the potential group by comparing the text, the concepts, or both in the potential group of instance identifiers to the text, the concepts, or both in the source document.

The system performing process 600 ranks the potential groups according to the relevance of source document to query, the likelihood that potential group of instance identifiers is a group, and the relevance of potential group to source document (step 620). For example, a merit score “S_{G}” can be computed for each potential group of instance identifiers according to a formula that relies upon multiplication, addition, exponentiation, or other computation using the relevance of the source document of the potential group of instance identifiers to the query, the likelihood that the potential group of instance identifiers is in fact a group, and the relevance of the potential group of instance identifiers to the source document that includes the potential group of instance identifiers. For example, in some implementations, the merit score “S_{G}” is computed for each potential group of instances according to the formula:

S_{G}=R_{DQ}L_{G}R_{GD} Equation 1

where “R_{DG}” is the relevance of the source document of the potential group of instance identifiers to the query, “L_{G}” is the likelihood that the potential group of instance identifiers is in fact a group, and “R_{GD}” is the relevance of the potential group of instance identifiers to the source document that includes it. The merit score S_{G} of each potential group of instance identifiers can thus embody the relevance of those potential groups to a search query.

As another example, a merit score “S_{G}” can be computed for each potential group of instance identifiers using machine-learning techniques. For example, the relevance of source document to query, the likelihood that potential group of instance identifiers is a group, and the relevance of potential group to source document can be input into as features into a predictive analytic tree-building algorithm that has been trained using a groups of known relevance to a search query. The merit score “S_{G}” yielded by a predictive analytic tree-building algorithm can embody the percentage of decision trees that have voted for a group. This percentage can be expressed as a number between 0 and 1. In some implementations, the percentage of decision trees that have voted for a group can be adjusted to account for factors such as the number of times that a group appears, the extent to which the members of the group have been refined, and other factors.

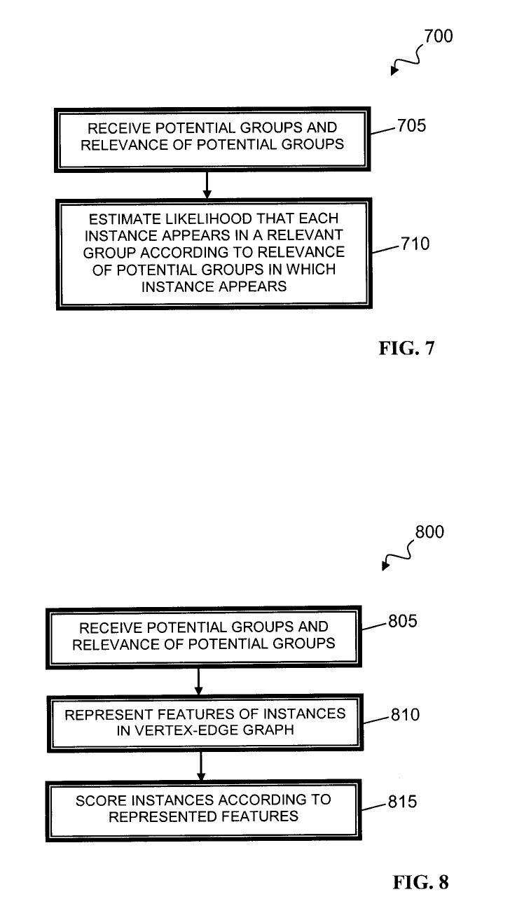

FIG. 7 is a flow chart of a process 700 for scoring instance identifiers according to relevance of groups in which instance identifiers appear. Process 700 can be performed by one or more computers that perform digital data processing operations by executing one or more sets of machine-readable instructions. For example, process 700 can be performed by the search engine 105 in system 100 (FIG. 1). Process 700 can be performed in isolation or in conjunction with other digital data processing operations. For example, process 700 can be performed in conjunction with the activities of process 200, e.g., at step 230 (FIG. 2).

The system performing process 700 receives description information describing potential groups (including the identity of the instance identifiers in the potential groups) and the relevance of these potential groups to a search query (step 705). For example, the system can receive a listing of the instance identifiers in each potential group and a merit score S_{G} for each potential group.

The system performing process 700 estimates the likelihood that each instance identifier appears in a relevant group according to relevance of potential groups in which instance identifier appears (step 710). A group of instance identifiers is relevant to a search query when the group includes instance identifiers that share the attributes that are implicitly or explicitly specified in the search query. The likelihood that each instance identifier appears in a relevant group can thus embody the relevance of the instance identifier to a search query.

In some implementations, the likelihood that each instance identifier appears in a relevant group is estimated according to a method that relies on an expectation maximization algorithm. An expectation maximization algorithm makes maximum-likelihood estimates of one or more parameters of a distribution from a set of data that is incomplete and missing variables. An expectation maximization algorithm can pick a set of parameters that best describes a set of data given a model.

In the present context, the set of data are the potential groups. The model assumes that some potential group are relevant to the query (groups “R”) whereas other potential groups are not relevant to the query (groups “N”). Further, a given item (i) has a probability of occurring in a relevant group “P(i|R)” and a probability of occurring in an irrelevant group “P(i|N)”. The probabilities P(i|R), P(i|N) can initially be estimated based on, e.g., the relevance of the source document of the group to a search query, the likelihood that a group of instances is indeed a group, and the relevance of the group to its source document. The probabilities P(i|R), P(i|N) can then be maximized using the expectation maximization algorithm.

The expectation maximization algorithm can be implemented as iterative processes which alternates between expectation steps and maximization steps. In expectation steps, missing variables are estimated from the observed data and current estimates of the parameters of the distribution. In maximization steps, estimates of the parameters of the distribution is maximized under the assumption that the missing variables are known, i.e., have the values estimated in the previous expectation step. As the steps are iteratively repeated, the estimates of the parameters of the distribution converge. Expectation maximization algorithms are described in more detail, e.g., in “Maximum Likelihood from Incomplete Data via the EM Algorithm” by A. P. Dempster, N. M. Laird, D. B. Rubin Journal of the Royal Statistical Society, Series B (Methodological) 39 (1) pp. 1-38 (1977).

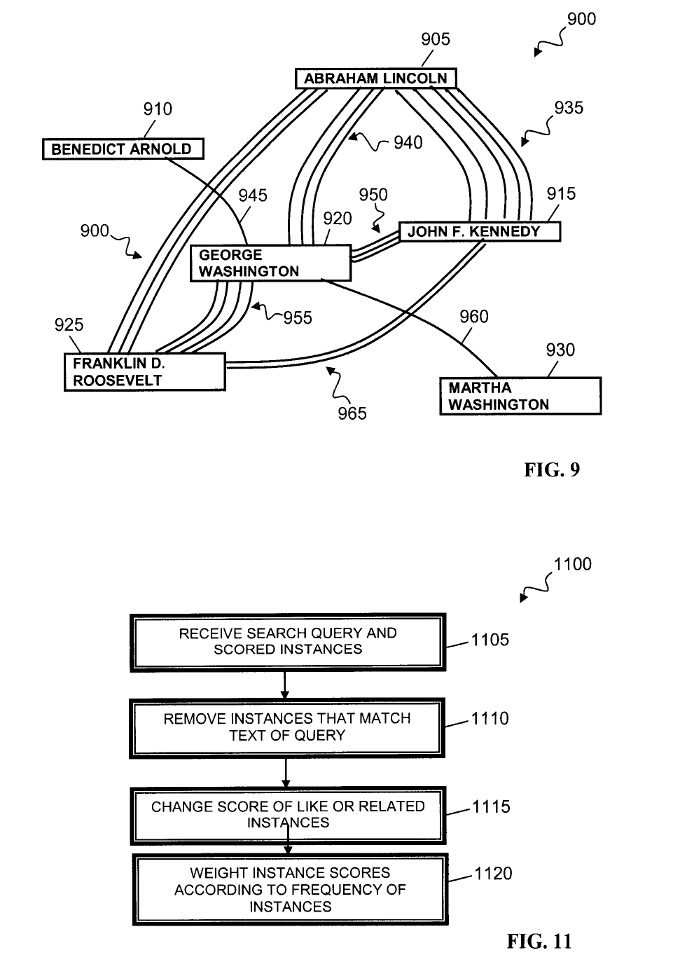

FIG. 8 is a flow chart of a process 800 for scoring instance identifiers according to the relevance of groups in which instance identifiers appear. Process 800 can be performed by one or more computers that perform digital data processing operations by executing one or more sets of machine-readable instructions. For example, process 800 can be performed by the search engine 105 in system 100 (FIG. 1). Process 800 can be performed in isolation or in conjunction with other digital data processing operations. For example, process 800 can be performed in conjunction with the activities of process 200, e.g., at step 230 (FIG. 2).

The system performing process 800 receives description information describing potential groups (including the identity of the instance identifiers in the potential groups) and the relevance of these potential groups to a search query (step 805). For example, the system can receive a listing of the instance identifiers in each potential group and a merit score S_{G} for each potential group.

The system performing process 800 represents features of the instance identifiers in the potential groups in one or more vertex-edge graphs (step 810). A vertex-edge graph is a representation of a set of objects where some pairs of the objects are connected by links. The interconnected objects are represented by vertices and the links that connect some pairs of vertices are called edges.

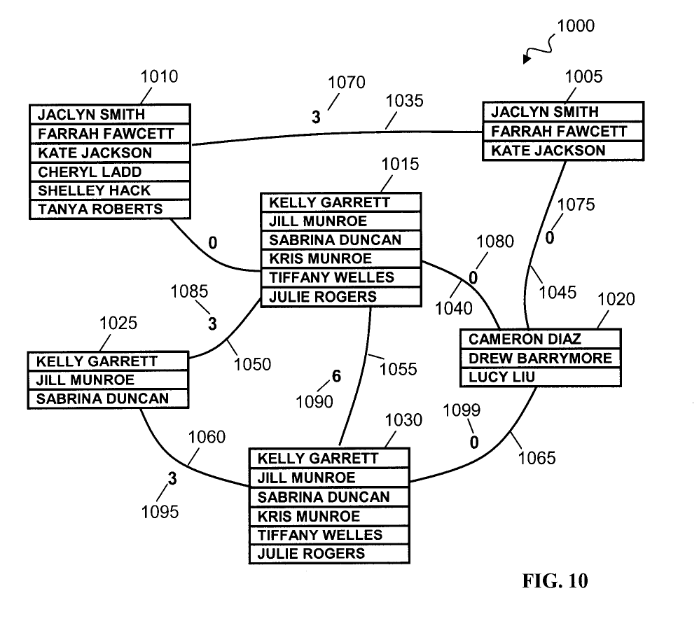

FIG. 9 is a schematic representation of a vertex-edge graph 900 that represents features of the instance identifiers in the potential groups. Vertex-edge graph 900 includes vertices 905, 910, 915, 920, 925, 930 that are connected pairwise by groups of one or more edges 935, 940, 945, 950, 955, 960, 965. Vertex-edge graph 900 is a undirected graph.

Each of vertices 905, 910, 915, 920, 925, 930 represents an instance identifier which is found in a potential group that was identified in one or more searches. For example, vertex 920 represents the instance identifier “George Washington,” vertex 920 represents the instance identifier “Franklin D. Roosevelt,” and vertex 930 represents the instance identifier “Martha Washington.” The potential groups from which vertices 905, 910, 915, 920, 925, 930 are drawn can be constrained to have at least some threshold level of relevance to the search query. The relevance of the potential groups to the search query can be determined, e.g., using process 600 (FIG. 6).

Each group of edges 935, 940, 945, 950, 955, 960, 965 represents co-occurrences of the vertices connected by the edges in a potential group. For example, the four different edges in edge group 955 can represent that “George Washington” vertex 920 was found in four potential groups that also included “Franklin D. Roosevelt.” In some implementations, other features can be can be represented by edges. Table 1 is a list of examples of such features.

TABLE 1
EXAMPLE FEATURES

query that identified source document that includes vertex pair;
class of query (e.g., biased query, source-constrained query) that
identified source document(s) that include vertex pair;
number of potential groups identified by the query that identified source
document(s) that include vertex pair;
relevance of the source document
source document of the vertex pair;
extractor that identified vertex pair;
other instances in potential groups where vertex pair is found;

In some implementations, other features that can be represented by edges can be determined from the characteristics of neighboring items.

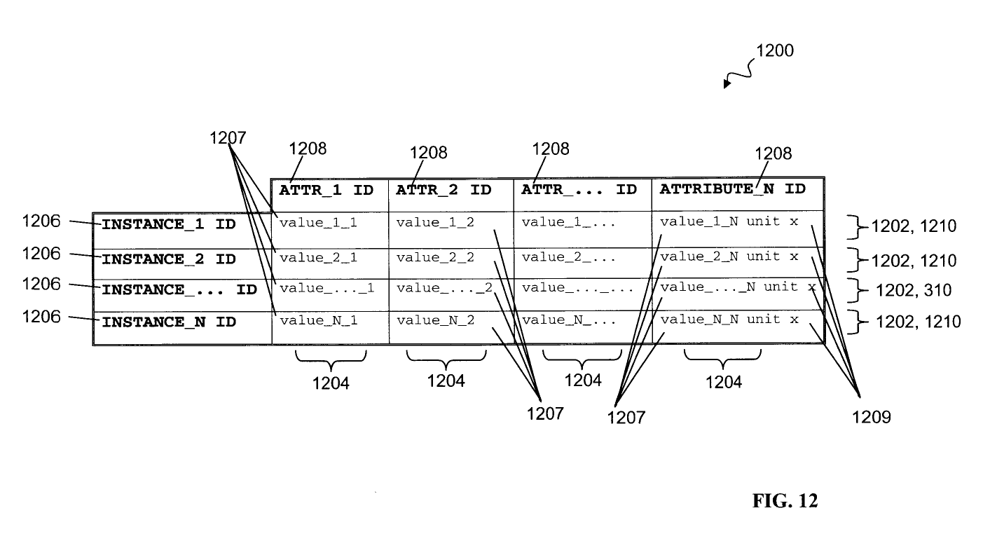

FIG. 10 is a schematic representation of another vertex-edge graph 1000 that represents features of the instance identifiers in the potential groups. Vertex-edge graph 1000 includes vertices 1005, 1010, 1015, 1020, 1025, 1030 that are connected pairwise by individual edges 1035, 1040, 1045, 1050, 1055, 1060, 1065. Each of edges 1035, 1040, 1045, 1050, 1055, 1060, 1065 is weighted by a respective weight 1070, 1075, 1080, 1085, 1090, 1095, 1099. Vertex-edge graph 1000 is thus a weighted undirected graph.

Each of vertices 1005, 1010, 1015, 1020, 1025, 1030 represents a potential group of instance identifiers. For example, vertex 1015 represents a group of six instance identifiers, vertex 1020 represents a group of three instance identifiers, and vertex 1025 represents a group of three instance identifiers. The potential groups represented in vertices 1005, 1010, 1015, 1020, 1025, 1030 can be constrained to have at least some threshold level of relevance to the search query. The relevance of the potential groups to the search query can be determined, e.g., using process 600 (FIG. 6).

Each of edges 935, 940, 945, 950, 955, 960, 965 represents the “overlap” between the pair of vertices it connects. The “overlap” between two vertices is the number of instance identifiers common to the potential groups represented by those vertices. The overlap can be represented by the respective weight 1070, 1075, 1080, 1085, 1090, 1095, 1099 associated with each edge 935, 940, 945, 950, 955, 960, 965. For example, weight 1080 represents that there are no instance identifiers which are common to the potential groups represented by vertices 1015, 1020 and weight 1085 represents that there are three instance identifiers which are common to the potential groups represented by vertices 1015, 1025. For the sake of clarity, other zero weight edges have been omitted from vertex-edge graph 1000. Vertex-edge graph 1000 thus represents the overlap between the potential groups in which instance identifiers are found.

The vertices and edges of graphs 900, 1000 need not be displayed in pictorial form, as shown. Rather, graphs 900, 1000 can remain abstract representations, e.g., in a computer that performs digital data processing operations.

Returning to FIG. 8, the system performing process 800 scores the instance identifiers in the potential groups according to the features represented by the edges in the vertex-edge graph (step 815). The nature of the scoring can depend on the features represented in the vertex-edge graph as well as the role of the instance identifiers themselves in the vertex-edge graph.

In some implementations, the instance identifiers in the potential groups can be scored using the result of a machine-learning technique performed by a computers that executes one or more sets of machine-readable instructions. A training set of data can first be used to allow a machine to establish a set of rules for scoring instance identifiers. This set of rules for scoring can then be applied to other sets of data.

For example, in the context of vertex-edge graph 900 (FIG. 9), a predictive analytic tree-building algorithm such as classification and regression tree analysis can score the instances according to the likelihood that they belong in a relevant group, classify the instance identifiers as to whether they belong in a relevant group, or both. Tree-building algorithms determine a set of if-then logical rules for scoring instance identifiers that permit accurate prediction or classification of cases. Trees are built by a collection of rules based on values of variables in a modeling data set. The rules can be selected based on how well splits based on the values of different variables can differentiate observations. Examples of tree-building algorithms are described, e.g., in: “Classification and Regression Trees,” Breiman et al., Chapman & Hall (Wadsworth, Inc.) New York (1984); “CART: Tree-structured Non-parametric Data Analysis,” Steinberg et al., Salford Systems, San Diego, Calif., U.S.A. (1995); and “Random Forests,” Breiman, Machine Learning, Vol. 45:1. (2001), pp. 5-32.

Such a predictive analytic tree-building algorithm can be trained using a group of instance identifiers of confirmed accuracy that are relevant to a search query, a set of potential groups of instance identifiers that have been identified from an unstructured collection of electronic documents, and features of the instance identifiers in the potential groups. The decision trees can make their decisions based on features, e.g., the features listed in Table 1. For example, an exhaustive list of the Presidents of the United States of America, a set of potential groups of instance identifiers that have been identified in response to a search query inquiring about the Presidents of the United States of America, and features of the instance identifiers in these potential groups can be used by a machine to establish a classification and regression tree. The set of if-then logical rules for scoring in this classification and regression tree can then be applied to other sets of potential groups of instance identifiers that have been identified in response to other search queries, as well as the features of the instance identifiers in these other potential groups. The application of these logical conditions can score the instance identifiers in these other potential groups according to the likelihood that they belong in a relevant group, classify the instances as to whether they belong in a relevant group, or both.

In some implementations, the instance identifiers in the potential groups can be scored by identifying cliques in a vertex-edge graph. A clique is a set of pairwise adjacent vertices, or in other words, an induced subgraph which is a complete graph. The size of a clique is the number of vertices within the clique. In the context of vertex-edge graph 1000 (FIG. 10), vertices 1015, 1030 form a complete bipartite graph (or a “biclique”) in which every instance identifier in vertex 1015 is also found in vertex 1030. This high degree of overlap is represented by the relatively high value of weight 1090 (i.e., a value of six). Vertices 1015, 1025 have a middling degree of overlap and share only three constituent instance identifiers. This middling degree of overlap is represented by the intermediate value of weight 1085 (i.e., a value of three). Vertices 1020, 1030 do not overlap at all and this lack of overlap is represented by the zero value of weight 1099.

The identification of cliques and the overlap between vertices can be used to score the instance identifiers in the potential groups represented by these vertices. For example, instance identifiers in large cliques and/or with a high degree of overlap can be treated as more likely to have the attributes specified by a search query, whereas instance identifiers in small cliques and/or with a low degree of overlap can be treated as less likely to have the attributes specified by the search query. In some implementations, the size of the clique can be weighted more heavily in scoring than the degree of overlap in smaller cliques. For example, vertices 1015, 1025, 1030 form a three-vertex clique edges having edges with a minimum weight of three, whereas vertices 1015, 1030 form a two-vertex clique edges having edges with a minimum weight of six. The larger three-vertex clique can be taken as a collection of independent sources confirming that three common instance identifiers are likely to have the attributes specified by a search query. In some implementations, a representation of the set of scored instance identifiers can then be transmitted to a client, e.g., client 115 in system 100 (FIG. 1).

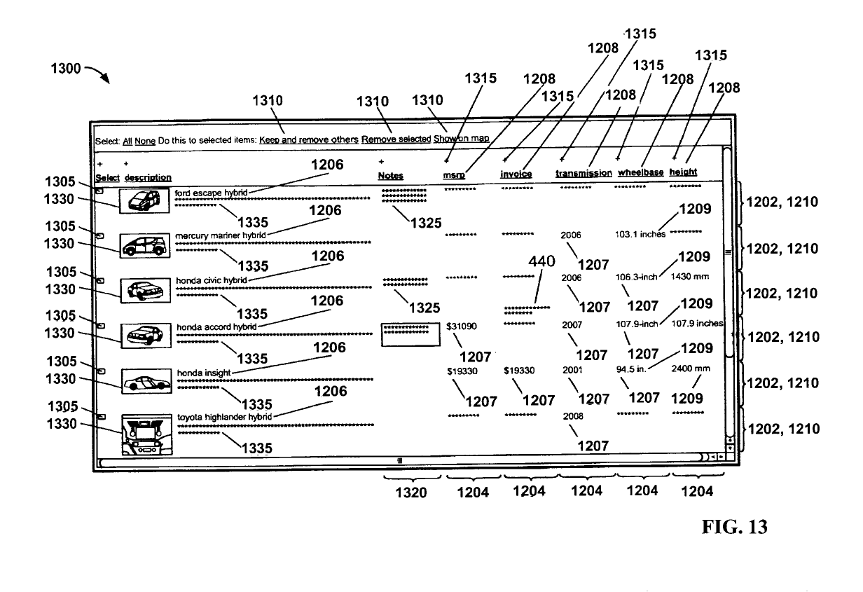

FIG. 11 is a flow chart of a process 1100 for rescoring instance identifiers. Process 1100 can be performed by one or more computers that perform digital data processing operations by executing one or more sets of machine-readable instructions. For example, process 1100 can be performed by the search engine 105 in system 100 (FIG. 1). Process 1100 can be performed in isolation or in conjunction with other digital data processing operations. For example, process 1100 can be performed in conjunction with the activities of process 700, e.g., after step 710 (FIG. 7) or in conjunction with the activities of process 800, e.g., after step 815 (FIG. 8).

The system performing process 1100 receives description information describing a search query and a collection of scored instance identifiers (step 1105). The instance identifiers can be scored according to the likelihood that they have the attributes specified by the received search query.

The system performing process 1100 can remove instance identifiers that match the text of the received search query, or permutations of the text of the received search query (step 1110). For example, if a search queries that inquires about “U.S. Presidents,” instance identifiers such as “presidents,” “U.S. President,” and the like can be removed from the set of scored instance identifiers. In some implementation, other instance identifiers such as vulgar words can be removed from the set of scored instance identifiers.

The system performing process 1100 can change the score of like or related instance identifiers in a set of scored instance identifiers (step 1115). Examples of like or related instance identifiers include that which identify the same instance using words that originate from different orthographies (e.g., defense/defence, behavior/behaviour), words that are different transliterations of foreign words (e.g., tsar/czar/csar), words that are abbreviations or diminutives (Robert Kennedy/Bobby Kennedy/R. F. Kennedy), and words that are a substring of another instance identifier (e.g., George Washington/Biography of George Washington). In some implementations, like or related instance identifier can be combined into a single instance identifier.

The system performing process 1100 can also weight the scores of instance identifiers according to the frequency at which the instance identifiers appear in the electronic documents of an unstructured electronic documents collection (step 1120). For example, as a group of electronic documents is being indexed, the number of occurrences of different terms (including the instance identifier terms) appearing in the electronic documents can be determined. The scores for different instance identifiers can then be scaled, e.g., by multiplying the scores by a value that is approximately the inverse of the number of occurrences. As a result, the scores of instance identifiers that appear often in the electronic documents can be decreased relative to the scores of instance identifiers that appear only rarely in the electronic documents.

In some implementations, other activities can be used to rescore a collection of instances. For example, in some implementations, instance identifiers that match a fixed blacklist can be removed from the collection altogether, in effect, reducing their score to zero. The blacklist can include individual instance identifiers or identifier/search query pairs.

In some implementations, the score of an instance identifier can be changed to reflect the likelihood that the identifier characterizes a category of instances. In some implementations, the likelihood that the identifier characterizes a category of instances can be determined from a log of search queries submitted by different human users. For example, in response to a user switching between searching with a search query that identifies a scored instance (e.g., the search query “car”) to searching with a search query that uses that identifier to identify a category (e.g., the search queries “types of car” and “list of cars”), the score of that instance identifier can be decreased. As another example, in response to a user switching between searching with a search query that identifies a scored instance (e.g., the search query “car”) to searching with an identifier of a more specific instance within that category (e.g., the search query “prius” within the category “car”), the score of the more specific instance identifier can be increased.

In some implementations, a representation of the set of rescored instance identifier can then be transmitted to a client, e.g., client 115 in system 100 (FIG. 1).

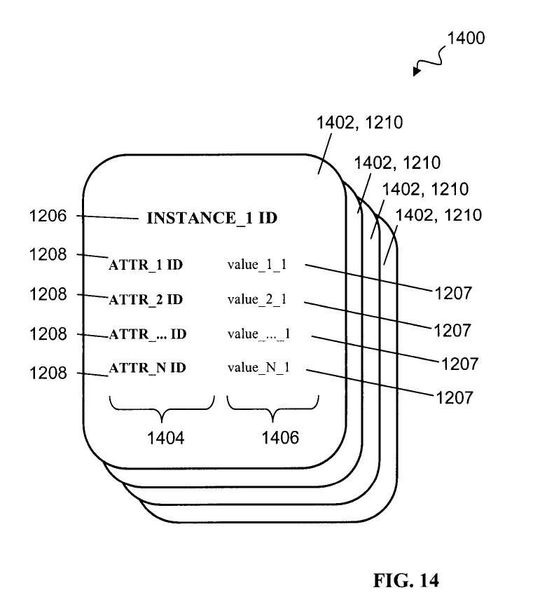

FIGS. 12-14 are examples of structured presentations 1200, 1300, 1400 that present a group of related instance identifiers to user. Structured presentations 1200, 1300, 1400 can be presented to a user, e.g., by client 115 in presentation 125 on display screen 120 (FIG. 1). Structured presentations 1200, 1300, 1400 use the spatial arrangement and positioning of information to identify that a group of instance shares one or more common attributes.

FIG. 12 is a schematic representation of an example table structured presentation 1200. Table 1200 is an organized, systematic arrangement of one or more identifiers of instances, as well as the values of particular attributes shared by those instances. In some implementations, structured presentations such as table 1200 can also include identifiers of attributes shared by those instances, as well as identifiers of the units in which values are expressed.

The grouping, segmentation, and arrangement of information in table 1200 can be selected to facilitate understanding of the information by a user. In this regard, table 1200 includes a collection of rows 1202. Each row 1202 includes an instance identifier 1206 and a collection of associated attribute values 1207. The arrangement and positioning of attribute values 1207 and instance identifiers 1206 in rows 1202 thus graphically represents the associations between them. For example, a user can discern the association between attribute values 1207 and the instance identifier 1206 that is found in the same row 1202.

Table 1200 also includes a collection of columns 1204. Each column 1204 includes an attribute identifier 1208 and a collection of associated attribute values 1207. The arrangement and positioning of attribute values 1207 and attribute identifier 1208 in columns 1204 thus graphically represent the associations between them. For example, a user can discern the association between attribute values 1207 and the attribute identifier 1208 that is found in the same column 1204 based on their alignment.

Each row 1202 is a structured record 1210 in that each row 1202 associates a single instance identifier 1206 with a collection of associated attribute values 1207. Further, the arrangement and positioning used to denote these associations in one structured record 1210 is reproduced in other structured records 1210 (i.e., in other rows 1202). Indeed, in many cases, all of the structured records 1210 in a structured presentation 106 are restricted to having the same arrangement and positioning of information. For example, values 1207 of the attribute “ATTR_{—}2” are restricted to appearing in the same column 1204 in all rows 1202. As another example, attribute identifiers 1208 all bear the same spatial relationship to the values 1207 appearing in the same column 1204. Moreover, changes to the arrangement and positioning of information in one structured record 1210 are generally propagated to other structured records 1210 in the structured presentation 1200. For example, if a new attribute value 1207 that characterizes a new attribute (e.g., “ATTR_{—}2¾”) is added to one structured record 1210, then a new column 1204 is added to structured presentation 106 so that the values of attribute “ATTR_{—}2¾” of all instances can be added to structured presentation 106.

In some implementations, values 1207 in table 1200 can be presented in certain units of measure. Examples of units of measure include feet, yards, inches, miles, seconds, gallons, liters, degrees Celsius, and the like. In some instances, the units of measure in which values 1207 are presented are indicated by unit identifiers 1209. Unit identifiers 1209 can appear, e.g., beside values 1207 and/or beside relevant attribute identifiers 1208. The association between unit identifiers 1209 and the values 1207 whose units of measure are indicated is indicated to a viewer by such positioning. In many cases, all of the values 1207 associated with a single attribute (e.g., all of the values 1207 in a single column 1204) are restricted to being presented in the same unit of measure.

The instances in a group of related instances (such as described in message 140 (FIG. 1)) can be used to populate table 1200 or other structured presentation in a variety of different ways. For example, a structured presentation can be populated with related instances in response to a search query. For example, the individual instances most relevant to the search query can be displayed in the structured presentation by default. A user can alter, or attempt to alter, those instances by, e.g., interacting with or referring to the structured presentation. Other instances can be presented as candidates for replacing the instances which the search engine has determined are most likely to be relevant to the search query.

FIG. 13 is a schematic representation of another implementation of a structured presentation, namely, a structured presentation table 1300. In addition to including attribute identifiers 1208, instance identifiers 1206, values 1207, unit identifiers 1209 organized into rows 1202 and columns 1204, table 1300 also includes a number of interactive elements for interacting with a user. In particular, table 1300 includes a collection of instance selection widgets 1305, a collection of action triggers 1310, a collection of column action trigger widgets 1315, and a notes column 1320.

Instance selection widgets 1305 are user interface components that allow a user to select structured records 1210 in table 1300. For example, instance selection widgets 1305 can be a collection of one or more clickable checkboxes that are associated with a particular structured record 1210 by virtue of arrangement and positioning relative to that structured record 1210. Instance selection widgets 1305 are “clickable” in that a user can interact with widgets 1305 using a mouse (e.g., hovering over the component and clicking a particular mouse button), a stylus (e.g., pressing a user interface component displayed on a touch screen with the stylus), a keyboard, or other input device to invoke the functionality provided by that component.

Action triggers 1310 are user interface components that allow a user to trigger the performance of an action on one or more structured records 1210 in table 1300 selected using instance selection widgets 1305. For example, action triggers 1310 can be clickable text phrases, each of which can be used by a user to trigger an action described in the phrase. For example, a “keep and remove others” action trigger 1310 triggers the removal of structured records 1210 that are not selected using instance selection widgets 1305 from the display of table 1300. As another example, a “remove selected” action trigger 1310 triggers the removal of structured records 1210 that are selected using instance selection widgets 1305 from the display of table 1300. As yet another example, a “show on map” action trigger 1310 triggers display of the position of structured records 1210 that are selected using instance selection widgets 1305 on a geographic map. For example, if a selected instance is a car, locations of car dealerships that sell the selected car can be displayed on a map. As another example, if the selected instances are vacation destinations, these destinations can be displayed on a map.

Column action trigger widgets 1315 are user interface components that allow a user to apply an action to all of the cells within a single column 1204. When a user interacts with the clickable ‘+’ sign, a further user interface component is displayed which offers to the user a set of possible actions to be performed. The actions in this set can include, e.g., removing the entire column 1204 from the structured presentation 1300 or searching to find values for all the cells in column 1204 which are currently blank.

Notes column 1320 is a user interface component that allows a user to associate information with an instance identifier 1206. In particular, notes column 1320 includes one or more notes 1325 that are each associated with a structured record 1210 by virtue of arrangement and positioning relative to that structured record 1210. The information content of notes 1325 is unrestricted in that, unlike columns 1204, notes 1325 are not required to be values of any particular attribute. Instead, the information in notes 1325 can characterize unrelated aspects of the instance identified in structured record 1210.

In some implementations, table 1300 can include additional information other than values of any particular attribute. For example, table 1300 can include a collection of images 1330 that are associated with the instance identified in a structured record 1210 by virtue of arrangement and positioning relative to that structured record 1210. As another example, table 1300 can include a collection of text snippets 1335 extracted from electronic documents in collection 102. The sources of the snippets can be highly ranked results in searches conducted using instance identifiers 1206 as a search string. Text snippets 1335 are associated with the instance identified in a structured record 1210 by virtue of arrangement and positioning relative to that structured record 1210.

As another example, table 1300 can include one or more hypertext links 1340 to individual electronic documents in an electronic document collection. For example, the linked documents can be highly ranked results in searches conducted using instance identifiers 1206 as a search string. As another example, the linked documents can be source of a value 1207 that was extracted to populate table 1300. In some instances, interaction with hypertext link 1340 can trigger navigation to the source electronic document based on information embedded in hypertext link 1340 (e.g., a web site address).

FIG. 14 is a schematic representation of another implementation of a structured presentation, namely, a card collection 1400. Card collection 1400 is an organized, systematic arrangement of one or more identifiers of instances, as well as the values of particular attributes of those instances. The attributes of an instance can be specified by values. Moreover, card collection 1400 generally includes identifiers of attributes, as well as identifiers of the units in which values are expressed, where appropriate.

The grouping, segmentation, and arrangement of information in card collection 1400 can be selected to facilitate an understanding of the information by a user. In this regard, card collection 1400 includes a collection of cards 1402. Each card 1402 includes an instance identifier 1206 and a collection of associated attribute values 1207. The arrangement and positioning of attribute values 1207 and instance identifiers 1206 in cards 1402 thus graphically represents the associations between them. For example, a user can discern the association between attribute values 1207 and the instance identifier 1206 that is found on the same card 1402.

In the illustrated implementation, cards 1402 in card collection 1400 also include a collection of attribute identifiers 1208. Attribute identifiers 1208 are organized in a column 1404 and attribute values 1207 are organized in a column 1406. Columns 1404, 1406 are positioned adjacent one another and aligned so that individual attribute identifiers 1208 are positioned next to the attribute value 1207 that characterizes that identified attribute. This positioning and arrangement allows a viewer to discern the association between attribute identifiers 1208 and the attribute values 1207 that characterize those attributes.

Each card 1402 is a structured record 1210 in that each card 1402 associates a single instance identifier 1206 with a collection of associated attribute values 1207. Further, the arrangement and positioning used to denote these associations in one card 1402 is reproduced in other cards 1402. Indeed, in many cases, all of the cards 1402 are restricted to having the same arrangement and positioning of information. For example, the value 1207 that characterizes the attribute “ATTR_{—}1” is restricted to bearing the same spatial relationship to instance identifiers 1206 in all cards 1402. As another example, the order and positioning of attribute identifiers 1208 in all of the cards 1402 is the same. Moreover, changes to the arrangement and positioning of information in one card 1402 are generally propagated to other cards 1402 in card collection 1400. For example, if a new attribute value 1207 that characterizes a new attribute (e.g., “ATTR_{—}1¾”) is inserted between the attribute values “value_{—}1_{—}1” and “value 2_{—}1” in one card 1402, then the positioning of the corresponding attribute values 1207 in other cards 1402 is likewise changed.

In some implementations, cards 1402 in card collection 1400 can include other features. For example, cards 1402 can include interactive elements for interacting with a user, such as instance selection widgets, action triggers, attribute selection widgets, a notes entry, and the like. As another example, cards 1402 in card collection 1400 can include additional information other than values of any particular attribute, such as images and/or text snippets that are associated with an identified instance. As another example, cards 1402 in card collection 1400 can include one or more hypertext links to individual electronic documents in collection 102. Such features can be associated with particular instances by virtue of appearing on a card 1402 that includes an instance identifier 1206 that identifies that instance.

During operation, a viewer can interact with the system presenting card collection 1400 to change the display of one or more cards 1402. For example, a viewer can trigger the side-by-side display of two or more of the cards 1402 so that a comparison of the particular instances identified on those cards is facilitated. As another example, a viewer can trigger a reordering of card 1402, an end to the display of a particular card 1402, or the like. As another example, a viewer can trigger the selection, change, addition, and/or deletion of attributes and/or instances displayed in cards 1402. As yet another example, a viewer can trigger a sorting of cards into multiple piles according to, e.g., the values of an attribute values 1207 in the cards.

In some implementations, cards 1402 will be displayed with two “sides.” For example, a first side can include a graphic representation of the instance identified by instance identifier 1206, while a second side can include instance identifier 1206 and values 1207. This can be useful, for example, if the user is searching for a particular card in the collection of cards 1400, allowing the user to identify the particular card with a cursory review of the graphical representations on the first side of the cards 1402.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Accordingly, various modifications may be made.

What is claimed is:

1. A method performed by one or more data processing apparatus, the method comprising:
the data processing apparatus receiving a search query at a data processing apparatus, the search query specifying attributes shared by a group of related instances;
the data processing apparatus identifying groups of instance identifiers in an unstructured collection of electronic documents with the data processing apparatus;
the data processing apparatus determining relevance of the groups of instance identifiers to the search query with the data processing apparatus;
the data processing apparatus scoring at least some of the instance identifiers in the groups of instance identifiers individually with the data processing apparatus; and
the data processing apparatus ranking the at least some instance identifiers according to the scores with the data processing apparatus.

2. The method of claim 1, wherein determining the relevance of the groups of instance identifiers to the search query comprises:
computing relevance of the groups of instance identifiers to source documents that include the groups of instance identifiers;
computing likelihoods that the identified groups of instance identifiers are indeed groups of instance identifiers; and
computing relevance of source documents which include the groups of instance identifiers to the search query.

3. The method of claim 1, wherein identifying the groups of instance identifiers comprises:
forming a first new query biased to identify groups;
forming a second new query constrained to search compendia sources; and
searching the unstructured collection of electronic documents with the received query, the first new query, and the second new query.

4. The method of claim 1, further comprising the data processing apparatus rescoring the at least some instance identifiers before ranking.

5. The method of claim 1, wherein scoring at least some of the instance identifiers in the groups of instance identifiers comprises:
representing features of the instance identifiers in a vertex-edge graph; and
scoring the instance identifiers according to the features represented in the vertex-edge graph.

6. The method of claim 5, wherein:
vertices in the vertex-edge graph represent groups of instance identifiers; and
respective edges in the vertex-edge graph are weighted according to overlap between the vertices connected by the edge.

7. The method of claim 5, wherein:
vertices in the vertex-edge graph represent individual instance identifiers; and
respective edges in the vertex-edge graph represent features shared by the instance identifiers.

8. The method of claim 6, wherein a first edge in the vertex-edge graph represents an extractor that identified a pair of vertices joined by the first edge.

9. The method of claim 6, wherein a first edge in the vertex-edge graph represents other instance identifiers in potential groups where vertices joined by the first edge are found.

10. The method of claim 6, wherein a first edge in the vertex-edge graph represents a class of the query that identified source document where vertices joined by the first edge are found.

11. The method of claim 5, wherein scoring the instance identifiers comprises identifying cliques in the vertex-edge graph.

12. The method of claim 1, wherein scoring the instances identifiers comprises scoring the instance identifiers using a predictive analytic tree-building algorithm.

13. The method of claim 1, wherein scoring the instance identifiers using the predictive analytic tree-building algorithm comprises:
training the predictive analytic tree-building algorithm using
a group of instance identifiers of confirmed accuracy that are relevant to a search query,
a set of potential groups of instance identifiers that have been identified from an unstructured collection of electronic documents, and
features of the instance identifiers in the potential groups; and
generating a classification and regression tree.

14. One or more computer storage media encoded with a computer program, the program comprising instructions that when executed by one or more data processing apparatus cause the data processing apparatus to perform operations, the operations comprising:
receiving a search query at a data processing apparatus, the search query specifying attributes shared by a group of related instances;
searching an electronic document collection to identify identifiers of instance that are responsive to the search query;
representing features of the instance identifiers in a vertex-edge graph; and
scoring relevance of the instance identifiers to the search query according to the features represented in the vertex-edge graph.

15. The computer storage medium of claim 14, wherein:
the operations further comprise:
identifying groups of instance identifiers in the electronic documents of the collection; and
determining relevance of the groups of instance identifiers to the search query; and
a first feature represented in the vertex-edge graph comprises the relevance of the groups that include respective instance identifiers to the search query.

16. The computer storage medium of claim 14, the operations further comprising:
identifying electronic documents available on the Internet that are relevant to the search query; and
extracting groups of instance identifiers from the electronic documents that are relevant to the search query.

17. The computer storage medium of claim 16, the operations further comprising:
computing relevance of the electronic documents from which the groups of instance identifiers are extracted to the search query;
computing relevance of the groups of instance identifiers to the electronic documents from which the groups of instance identifiers are extracted; and
computing likelihoods that the groups of instance identifiers are groups of instance identifiers.

18. The computer storage medium of claim 15, wherein identifying the groups of instance identifiers comprises:
forming a new query biased to identify groups; and
searching the electronic document collection with the new query.

19. The computer storage medium of claim 14, wherein a first edge in the vertex-edge graph represents a class of the query that identified a pair of vertices joined by the first edge.

20. The computer storage medium of claim 14, wherein a first edge in the vertex-edge graph represents other instance identifiers in potential groups where vertices joined by the first edge are found.

21. The computer storage medium of claim 14, wherein scoring relevance of the instance identifiers to the search query comprises identifying cliques in the vertex-edge graph.

22. A system comprising:
a client device; and
one or more computers programmed to interact with the client device and the data storage device, the computers programmed to perform operations comprising:
receiving a search query from the client device, the search query explicitly or implicitly specifying attributes of instances;
searching an electronic document collection to identify identifiers of instances that may have the attributes specified by the search query;
representing features of the search of the electronic document collection in a vertex-edge graph;
scoring the instance identifiers that may have the attributes specified by the search query according to the features represented in the vertex-edge graph; and
outputting, the client device, instructions for visually presenting at least some of the instance identifiers.

23. The system of claim 22, wherein:
outputting the instructions comprises outputting instructions for visually presenting a structured presentation at the client device; and
the client device is configured to receive the instructions and cause the structured presentation to be visually presented.

24. The system of claim 22, further comprising a data storage device storing a data describing multiple groups of instances.

25. The system of claim 22, further comprising a data storage device storing machine-readable instructions tailored to identify and extract groups of instance identifiers from electronic documents in an unstructured collection.

26. The system of claim 22, wherein:
representing features comprises representing the relevance of the groups in which the instance identifiers appear in the vertex-edge graph; and
scoring the instance identifiers comprises scoring the instance identifiers individually according to the relevance of the groups in which the instance identifiers appear to the search query.

27. The system of claim 22, wherein scoring the instance identifiers comprises identifying cliques in the vertex-edge graph.

28. The system of claim 22, wherein scoring the instance identifiers comprises scoring the instance identifiers according to an extractor represented in the vertex-edge graph.

29. The system of claim 22, wherein scoring the instance identifiers comprises scoring the instance identifiers according to a class of a query represented in the vertex-edge graph.
